(19) United States
(12) Patent Application Publication
(10) Pub. No.: US 2009/0327381 A1
(43) Pub. Date: Dec. 31, 2009

(54) TRUE RANDOM NUMBER GENERATOR

(75) Inventor: Tomer Yosef Morad, Tel Aviv (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/164,234

(22) Filed: Jun. 30, 2008

(51) Int. Cl. G06F 7/58

(52) U.S. Cl. 708/252

(57) ABSTRACT

The present invention relates to an apparatus for generating a true random number comprising: (a) one or more decoupled oscillator(s), for generating a first set of one or more random bit(s); (b) one or more clock sampler(s), for generating a second set of one or more random bit(s); (c) a logic gate for logically combining said first set of one or more random bit(s) and said second set of one or more random bit(s) into a single true random bit; (d) a synchronizing circuit for synchronizing said single true random bit to the clock domain of said apparatus; (e) an LFSR, synchronized with said clock domain, which receives said synchronized single true random bit, and logically combines at least one of its internal bit(s) with said synchronized single true random bit for generating a true random number represented by the internal bits of said LFSR; and (f) an output bus for communicating said true random number from said LFSR.

### FIELD OF THE INVENTION

The present invention relates to the field of electrical circuits. More particularly, the invention relates to an apparatus for generating random numbers.

### BACKGROUND OF THE INVENTION

Random numbers are needed in a range of computing applications. One major example is the use of random numbers as keys in cryptography. Many cryptographic algorithms, such as the Data Encryption Standard (DES), utilize a key as part of the encryption process. In the case of DES, the key is 56 bits in length. Public-key algorithms like RSA and Elliptic Curve Cryptography require randomly generated key pairs. Furthermore, the Secure Sockets Layer (SSL) and other cryptographic protocols use random challenges in the authentication process to foil attacks.

There are many other applications besides cryptography that also make use of random numbers. These include, for example, electronic and computer games, to provide variety and unpredictability in the game, or simulators for system testing to generate random input data and then to assess the output, and so on.

Because of the widespread use of random numbers, a Random Number Generator (RNG) must be erratic enough so that even if the design of the RNG is known, its generated random number cannot be predicted. Typically, an RNG comprises an entropy generator to generate a seed that is then input into a hash function (e.g., SHA-1, MD5 etc.). However, a large number of RNGs actually utilize a deterministic process, i.e., a process whose outcome is predictable or semi-predictable, to generate a random number output from an initial seed. Therefore, a truly random seed is essential for the proper functioning of an RNG. A typical seed generator uses a non-deterministic source, such as, thermal or shot noise, e.g. the thermal or shot noise present when electrons flow through a resistor, to generate a seed. However, prior art RNGs of this type, typically use analog circuitry that includes at least an operation amplifier and a voltage control oscillator to generate the seed. The use of analog circuits in the prior art design of an RNG makes production of the RNG difficult. For example, due to the high voltage gain needed to amplify the thermal or shot noise, the output of the operation amplifier could become permanently saturated rendering the RNG useless.

LFSRs (Linear Feedback Shift Register) can be used as pseudo random number generators. This is because the output sequence of such an LFSR fulfills many of the statistical tests for random numbers (e.g. approximately even numbers of zeros and ones, and so on). However, the output sequence of such an LFSR is only pseudo-random, meaning that if the structure (polynomial) of the LFSR is known, then the future output can be determined absolutely, once the position within the maximal length sequence has been identified. This represents a potential exposure in a cryptographic system, in that once a hacker obtains knowledge of the LFSR polynomial and the identity of a single key provided by this system, then all future keys can be predicted. Some limited trial and error may be required, if the known key does not allow sequence position to be uniquely determined, but the search space and hence available security is greatly compromised in comparison with the original situation, where all possible keys would have to be investigated.

It is clearly desirable therefore to provide a random number generator that outputs a truly random (rather than pseudo random) number sequence. Unfortunately, it is not possible to generate truly random numbers using the main digital components of a computer system, since these are specifically intended to be deterministic.

Compatibility and fabrication problems can potentially manifest themselves in terms of reduced reliability for analog RNGs relative to LFSRs and similar digital devices. Of particular concern is the situation where an analog random number generator fails in the field. Note that such a failure may be only partial (for example certain bits in an output word may become stuck at a particular value). Such a degree of failure may not be immediately apparent, and so a cryptographic system may continue to produce keys using this “random” seed. However, it will be appreciated that in such circumstances the security of the system has been compromised, potentially severely. For example, if a hacker were to become aware of the deficiency mentioned above, then this would reduce the search space necessary to try to break a key in a brute force trial and error attack.

GB 2390271 describes an apparatus for generating a random number sequence. The apparatus comprises a digital pseudo-random number sequence generator, such as an LFSR, having a first output and an analog random number sequence generator (such as a Zener diode) having a second output. The pseudo-random number sequence on the first output and random number sequence on the second output are combined using a XOR operation which acts as a mixer to generate an output number sequence. However, since the apparatus's random number sequence relies specifically on the seed generated by a single analog generator, any failure, partial or full, in the analog random generator, may cause the generation of a pseudo-random output sequence.

It is an object of the present invention to provide an RNG which can generate a true random number overcoming the problems discussed above.

It is another object of the present invention to provide a fast True Random Number Generator based on natural processes.

It is still another object of the present invention to provide a minimized True Random Number Generator implementable in an integrated circuit using standard library cells.

Other objects and advantages of the invention will become apparent as the description proceeds.

### SUMMARY OF THE INVENTION

The present invention relates to an apparatus for generating a true random number comprising: (a) one or more decoupled oscillator(s), for generating a first set of one or more random bit(s); (b) one or more clock sampler(s), for generating a second set of one or more random bit(s); (c) a logic gate for logically combining said first set of one or more random bit(s) and said second set of one or more random bit(s) into a single true random bit; (d) a synchronizing circuit for synchronizing said single true random bit to the clock domain of said apparatus; (e) an LFSR, synchronized with said clock domain, which receives said synchronized single true random bit, and logically combines at least one of its internal bit(s) with said synchronized single true random bit for generating a true random number represented by the internal bits of said LFSR; and (f) an output bus for communicating said true random number from said LFSR.

Preferably, the apparatus further comprises a one-way function for further processing the communicated true random number.

Preferably, the clock sampler(s) have at least one flip-flop.

In one embodiment, the clock sampler(s) have 3 flip-flops.

Preferably, the logic gate is a XOR.

In one embodiment, the logic gate is a XNOR.

Preferably, the one-way function is a majority function.

In one embodiment, the one-way function is an AES whose outputs are XORed with its inputs.

### BRIEF DESCRIPTION OF THE DRAWINGS

In the drawings:

FIG. 1 is a schematic diagram of a True Random Number Generator, according to an embodiment of the invention.

FIG. 2 is a schematic diagram of a decoupled oscillator, according to an embodiment.

FIG. 3 is a schematic diagram of a clock sampler, according to an embodiment.

### DETAILED DESCRIPTION OF PREFERRED EMBODIMENTS

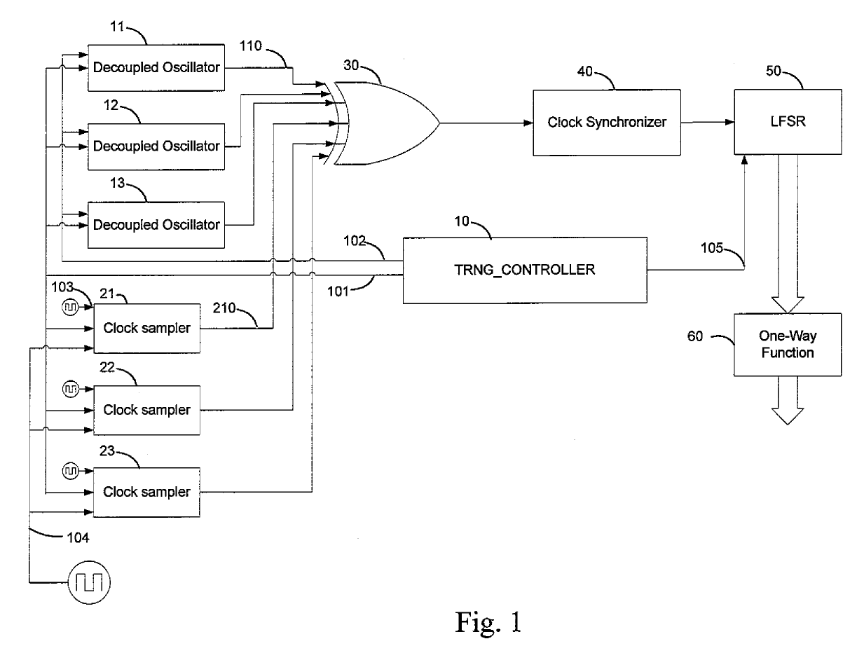

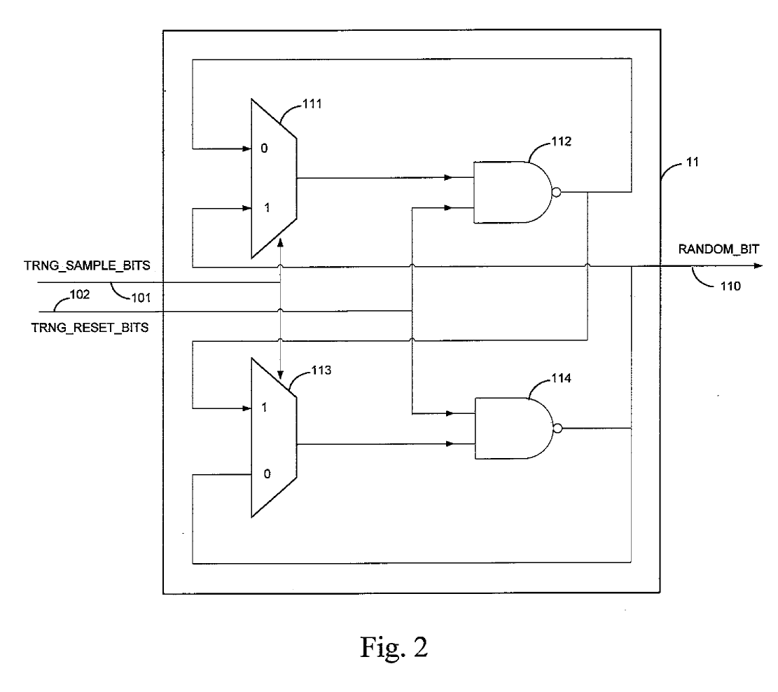

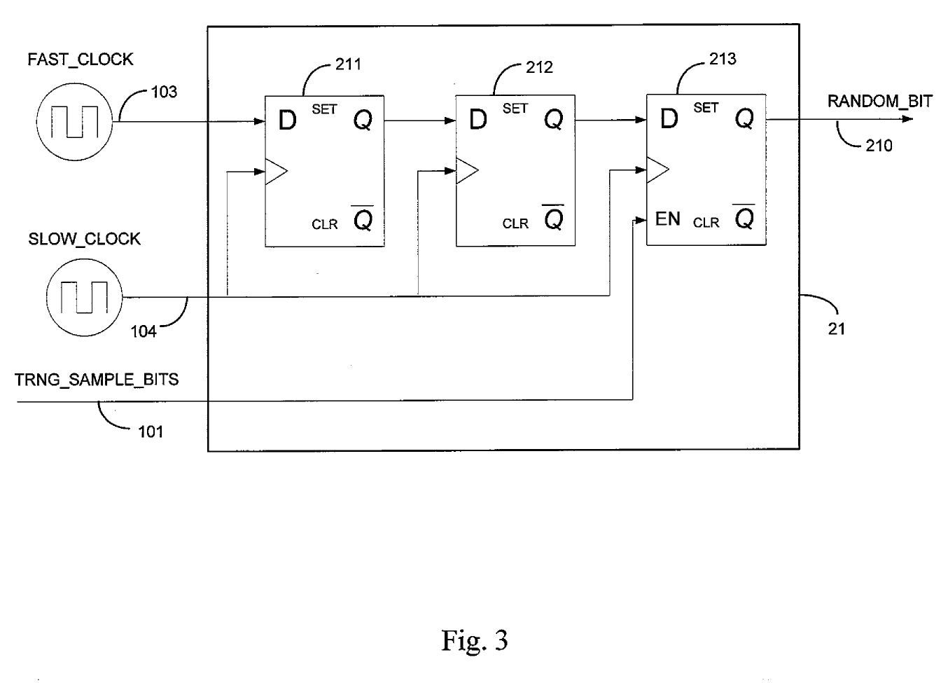

FIG. 1 is a schematic diagram of a True Random Number Generator (TRNG), according to an embodiment of the invention. In this embodiment TRNG_CONTROLLER 10 controls, on one hand, the LFSR 50, and, on the other hand, the analog elements, i.e. decoupled oscillators 11-13 and clock samplers 21-23, responsible for generating true random bits. By analog elements it is meant to include standard library cells, or in other words, not “custom made” elements. The TRNG_CONTROLLER 10 controls LFSR 50 using bus 105, and controls the analog elements using 2 buses: TRNG_SAMPLE_BITS bus 101 and TRNG_RESET_BITS bus 102. The internal operation of the decoupled oscillators 11-13 and the output line 110 are described below in relations to FIG. 2. The internal operation of the clock samplers 21-23 and the connecting lines 103, 104 and 210 are described below in relations to FIG. 3. Although, for the sake of brevity, in FIG. 1 only 3 decoupled oscillators 11-13 and only 3 clock samplers 21-23 are shown, the invention is better implemented using more oscillators and clock samplers. In other words: the more oscillators and clock samplers, the better the entropy of the TRNG. At first TRNG_CONTROLLER 10 uses the buses, TRNG_SAMPLE_BITS bus 101 and TRNG_RESET_BITS bus 102, to harvest random bits from decoupled oscillators 11-13 and the clock samplers 21-23. The harvested random bits, i.e. outputs of the decoupled oscillators 11-13 and the clock samplers 21-23, are then combined in the XOR gate 30 for generating a true random bit which is in effect the “seed” of the TRNG. In other embodiments, a different gate, or a combination of gates, can be used instead of XOR gate 30. The generated seed, i.e. the true random bit, is then fed into clock synchronizer 40 where it is synchronized with the clock of the LFSR 50. From clock synchronizer 40 the seed is fed into LFSR 50. The LFSR 50 may be a 128-bit or any other configuration of an LFSR. When the LFSR 50 receives as input one or more seed(s) from clock synchronizer 40, it can effectively generate a truly random number by XORing one or more of its internal bit(s) with the seed(s). Therefore, when the LFSR 50 receives the input of a seed, i.e. a true random generated bit, it can generate a true random number based on this seed. The seed may be inserted into the LFSR 50 in different intervals, such as every 3 feedback cycles of the LFSR, or any other suitable interval. This process is repeated continuously until TRNG_CONTROLLER 10 requests LFSR 50 to output its random number to a bus connected to the one-way function Block 60, effectively making the task of inverse engineering harder. The one-way function may be a 3−>1 majority function or any other one-way function, such as AES whose outputs are XORed with its inputs, SHA1, etc. From the one-way function Block 60 the processed random number is thus generated.

In one of the embodiments LFSR 50 is not reset at startup which in effect causes the LFSR 50 to startup with a random number. This feature can raise the entropy of the generated random number even further.

FIG. 2 is a schematic diagram of a decoupled oscillator, according to an embodiment. For the sake of brevity only decoupled oscillator 11, is described; however, all the other decoupled oscillators of the invention operate essentially in the same way. In addition, although only 1 decoupled oscillator is sufficient for yielding a random bit, the use of a number of oscillators in combination usually yields better entropy. As stated in relation to FIG. 1 TRNG_CONTROLLER 10 controls oscillator 11 using two busses: TRNG_SAMPLE_BITS Bus 101 and TRNG_RESET_BITS Bus 102. When the TRNG_SAMPLE_BITS 101 turns to ‘0’, the oscillator 11 begins oscillating. However, the outputs of NAND gates 112 and 114 quickly become decoupled due to drift and jitter caused by the variation of environmental parameters. When the TRNG_SAMPLE_BITS 101 turns ‘1’, the oscillator 11 enters a transitional state, and possibly a meta-stable state, which eventually causes the output bus 110 to settle for either a ‘0’ or a ‘1’ randomly. In order to ensure harvesting true random bits, a number of such decoupled oscillators are used, each with different types of library gates, and also different logic gates may be used. At the beginning of the oscillating phase, it is desirable that both MUXs 111 and 113 begin at the same phase (instead of the opposite phase). Therefore, TRNG_RESET_BITS 102 is lowered before TRNG_SAMPLE_BITS 101 is lowered, and it is raised one cycle after TRNG_SAMPLE_BITS 101 is lowered. For example, when TRNG_SAMPLE_BITS 101 is lowered to ‘0’, and TRNG_RESET_BITS 102 is ‘0’ the outputs of the NAND gates 112 and 114 respectively will generate a ‘1’ on bus RANDOM_BIT 110. However, when TRNG_RESET_BITS 102 is switched to ‘1’ while TRNG_SAMPLE_BITS 101 is still ‘0’, the outputs of NAND gates 112 and 114 start altering between ‘1’ and ‘0’ in an unpredictable pace. When TRNG_SAMPLE_BITS 101 is switched to ‘1’ while TRNG_RESET_BITS 102 is still ‘1’, oscillator 11 effectively becomes a latch and enters a steady state which generates on RANDOM_BIT 110 a steady ‘1’ or ‘0’. Thus, an unpredictable random bit has been generated by controlling TRNG_SAMPLE_BITS 101 and TRNG_RESET_BITS 102.

FIG. 3 is a schematic diagram of a clock sampler, according to an embodiment. For the sake of brevity only clock sampler 21, is described; however, all the other clock samplers of the invention operate in essentially the same way. In addition, although only 1 clock sampler is sufficient for yielding a random bit, the use of a number of clock samplers in combination usually yields better entropy. As stated in relation to FIG. 1 TRNG_CONTROLLER 10 controls clock sampler 21 using TRNG_SAMPLE_BITS 101 bus. Input bus 103 channels a signal from a FAST_CLOCK which may include any clock faster than the SLOW_CLOCK signal transmitted on bus 104. In a preferred embodiment each clock sampler receives a different fast clock signal, for better entropy. FAST_CLOCK transmits an alternating fast signal on bus 103 continuously to D flip-flop 211, however, only when flip-flop 211 receives a signal on bus 104 from the SLOW_CLOCK, does the flip-flop 211 open to receive and hold the signal from bus 103. In some of the cases the signal on bus 103 may alter during reception due to the violation of the setup and hold times of the flip-flop 211, causing flip-flop 211 to go into a transitional state. Nevertheless, the transitional metastable state of flip-flop 211 is temporary and the flip-flop 211 should eventually reach a steady state of either high or low with a probability that increases exponentially with the slow clock cycle time. Once flip-flop 212 receives and holds the transitional signal, for one clock cycle, the probability for steadying the signal increases even further. At the next clock cycle the signal is transferred from flip-flop 212 to flip-flop 213, which again reduces the probability of metastability. Flip-flop 213 holds the signal until it receives an Enable signal from TRNG_SAMPLE_BITS 101 bus. Thus, once the random bit is needed, TRNG_SAMPLE_BITS 101 bus signals clock sampler 21, effectively enabling flip-flop 213 to output a true random bit on RANDOM_BIT bus 210. In some of the embodiments, the metastability, difference between the frequencies of the clocks, and jitter are desirable since they increase the randomness of the true random bit.

In one of the embodiments, clock sampler 21, as described in relations to FIG. 3, may be implemented using a single D flip-flop having inputs and outputs as flip-flop 213. However, in this embodiment, the FAST_CLOCK 103 is connected directly to the D input. Although in some of the cases a metastable output may appear on RANDOM_BIT bus 210, the system can eventually guide the transitional output to a steady state either using clock synchronizer 40 as described in relations to FIG. 1, or any other electronic element. Other embodiments having different number of flip-flops may be used.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. An apparatus for generating a true random number comprising:
a. one or more decoupled oscillator(s), for generating a first set of one or more random bit(s);
b. one or more clock sampler(s), for generating a second set of one or more random bit(s);
c. a logic gate for logically combining said first set of one or more random bit(s) and said second set of one or more random bit(s) into a single true random bit;
d. a synchronizing circuit for synchronizing said single true random bit to a clock domain;
e. an LFSR, synchronized with said clock domain, which receives said synchronized 'single true random bit, and logically combines at least one of its internal bit(s) with said synchronized single true random bit for generating a true random number represented by the internal bits of said LFSR; and
f. an output bus for communicating said true random number.

2. An apparatus according to claim 1, further comprising a one-way function for further processing the communicated true random number.

3. An apparatus according to claim 1, where the clock sampler(s) have at least one flip-flop.

4. An apparatus according to claim 1, where the clock sampler(s) have 3 flip-flops.

5. An apparatus according to claim 1, where the logic gate is a XOR.

6. An apparatus according to claim 1, where the logic gate is a XNOR.

7. An apparatus according to claim 2, where the one-way function is a majority function.

8. An apparatus according to claim 2, where the one-way function is an AES whose outputs are XORed with its inputs.
